(19) United States
(12) Patent Application Publication
(10) Pub. No.: US 2002/0057323 A1
(43) Pub. Date: May 16, 2002

(54) Ink jet recording material

(76) Inventors: Yasuo Kurachi, Tokyo (JP); Eiichi Ueda, Tokyo (JP); Takayuki Sasaki, Tokyo (JP); Akihisa Nakajima, Tokyo (JP)

Correspondence Address: BIERMAN MUSERLIAN AND LUCAS, 600 THIRD AVENUE, NEW YORK, NY, 10016

(21) Appl. No.: 09/888,852

(22) Filed: Jun. 25, 2001

(30) Foreign Application Priority Data
Jun. 29, 2000 (JP) 196449/2000

(51) Int. Cl. B41J 2/01; B32B 1/00

(52) U.S. Cl. 347/105; 428/221

(57) ABSTRACT

An ink jet recording material is disclosed. The material comprises a support and an ink absorptive layer wherein the ink jet recording material has continuous ratio of voids of from 20 to 100 percent.

### FIELD OF THE INVENTION

The present invention relates to an ink jet recording material which records images utilizing color materials, and specifically to an ink jet recording material which exhibits high ink absorbability, high water resistance, high moisture resistance, and high glossiness, and results in minimized layer problems such as minute cracking and the like.

### BACKGROUND OF THE INVENTION

Ink jet recording is carried out in such a manner that minute ink droplets are allowed to jet utilizing various working principles, and to adhere onto a recording sheet such as paper and the like, so that images and text are recorded. Ink jet recording exhibits advantages of relatively high speed, low noise and ease of multicolor printing. Conventionally, an ink jet recording system has resulted in problems of nozzle clogging as well as high maintenance requirement. However, these drawbacks have been overcome through improvements of both aspects of ink and apparatus. Thus, currently, ink jet systems have been increasingly utilized in various fields such as printers, facsimile machines, computer terminals, and the like.

Said ink jet recording system is detailed, for example, in “Ink Jet Kiroku Gijutsu no Doko (Trend of Ink Jet Recording Techniques)” (edited by Koichi Nakamura, Mar. 31, 1995, published by Nihon Kagaku Joho Co., Ltd.).

Demanded as general performance for ink jet recording materials (hereinafter referred simply to as recording materials) are a high density of printed dots, bright and clear color tone, rapid ink absorption so that when ink dots are ejected onto the same position, ink neither flows, nor bleeds, no increased diffusion of printed dots in the lateral direction than as desired, and further smoothed but not blurred circumference of the ink jet dot. Specifically, those are generally employed in which an ink absorptive layer as a recording layer is applied.

Said ink absorptive layers are mainly divided into a so-called swelling type ink absorptive layer, which is mainly comprised of a hydrophilic binder, and a void type ink absorptive layer, which comprises a void layer in the recording layer.

Among these, an ink jet recording material, comprising a void type ink absorptive layer, comprises a support having thereon as the ink absorptive layer a void layer in which voids are formed by placing fine particles in the hydrophilic binder. Said material exhibits excellent ink absorbability, and tends not to result in beading of images after application of a large amount of ink. As a result, said material exhibits advantages that degradation of images is minimized, in the high density area compared to the swelling type material.

In recent years, a number of attempts have been made to approach image quality, obtained by color ink jet recording, to that of conventional photography. One of them is as follows: by employing particles having a small diameter, as well as low refractive index, as fine particles to form the void type ink absorptive layer, it is possible to form a layer having relatively high transparency. Further, at the same time, it is known that by employing fine silica particles having a low refractive index as well as a small diameter, it is possible to efficiently form voids and to obtain relatively high glossiness as well as high density images.

Further, in order to improve water resistance as well as the moisture resistance of dyes, heretofore, various methods have been proposed in which dyes are fixed in binders. Specifically effective methods include the addition of polymers having tertiary or quaternary nitrogen atoms, and numerous methods have been proposed. These are found in Japanese Patent Publication Open to Public Inspection Nos. 57-36692, 53-49113, 58-24492, 63-224988, 63-307979, 59-198186, 59-198188, 60-46288, 61-61887, 61-72581, 61-252189, 62-174184, 63-162275, 6-153798, and others.

While aiming at obtaining an ink jet recording material which exhibits high glossiness, the inventors of the present invention employed fine inorganic particles to form a void layer. As a result, it was noticed that fine cracks tended to occur on the coating surface depending on their content. Further, in order to improve water resistance as well as the moisture resistance of dye images, cationic polymers were incorporated into said void layer. As a result, it was also noticed that problems occurred in which fine cracks, as well as spot-shaped coating defects, tended to result.

Further, as described in Japanese Patent Publication Open to Public Inspection No. 57-14091, as a technique to enhance ink absorbability, it was proposed to provide voids. Heretofore, improvements have been made employing techniques such as the addition of fine particles. It has been known that when voids increase, ink absorbability is improved to enhance drying properties. However, due to an increase in the printing speed of printers, when employing conventional techniques, it has become difficult to obtain the desired sufficient drying speed of ink immediately after printing.

Further, in order to evaluate voids which affect ink absorbability, employed has been a mercury pressure inclusion method described, for example, in Japanese Patent Publication Open to Public Inspection No. 7-276789. However, when this method is employed, it is impossible to evaluate the continuity as well as the openness of said voids. As a result, it was impossible to evaluate said voids which were useful for absorbability as well as drying properties during ink jet printing. For example, when ink is jetted onto the surface of voids in a closed state, said ink is not absorbed due to the inner pressure applied by air in said voids. Thus, the absorbability for ink degrades to result in insufficient drying. Therefore, in order to create voids which are useful for improving ink absorbability as well as drying properties, an apparatus is needed which can evaluate the state of voids, other than their amount. Namely, voids are classified into three groups, that is, a completely closed void (called an independent void), a partially opened void (called a partially continuous void), and a completely opened void (called a continuous void). Accordingly, an apparatus is needed which makes it possible to evaluate the amount of voids obtained by subtracting the amount of voids such as independent voids, and the like, which do not effectively absorb ink, from the amount of voids comprised in the image receptive layer.

### SUMMARY OF THE INVENTION

From the view of the foregoing, the present invention has been accomplished. An objective of the present invention is to provide an ink jet recording material which exhibits excellent ink absorbability, water resistance, moisture resistance, and glossiness, and which further exhibits layer strength which minimizes the formation of fine cracks on the surface of an ink absorptive layer and spotted coating problems, and further to propose a novel method for evaluating ink absorbability, which has not been sufficiently evaluated employing conventional methods.

The aforementioned objective of the present invention was accomplished employing the embodiments described hereunder.

(1) An ink jet recording material wherein the continuous ratio of voids is from 20 to 100 percent.

(2) An ink jet recording material wherein the difference in the continuous ratio of voids before and after image formation is from 5 to 100 percent.

(3) The ink jet recording material described in (1) or (2) above comprising an ink absorptive layer.

(4) The ink jet recording material described in (1) or (2) above wherein said ink absorptive layer comprises at least 30 percent of voids formed by employing organic materials.

(5) The ink jet recording material described in (3) or (4) above wherein components which constitute voids in said ink absorptive layer exhibit ink absorbability.

(6) An ink jet recording material wherein said ink absorptive layer is comprised of at least two layers, and at least one layer is the ink absorptive layer described in any one of (3) through (5) above.

(7) An ink jet recording material wherein said ink absorptive layer is comprised of at least two layers; at least one layer comprises a layer having voids described in any one of (3) through (5) above; and the lower layer of the layer having said voids exhibits ink absorbability.

(8) A continuous rate measurement apparatus wherein an exhaust device is provide while a pressure sensor is provided before said exhaust device, and the continuous ratio of film surface or the entire film is measured.

### BRIEF DESCRIPTION OF THE DRAWING

FIG. 1 is a schematic view showing the continuous rate measurement apparatus of the present invention.

### DETAILED DESCRIPTION OF THE INVENTION

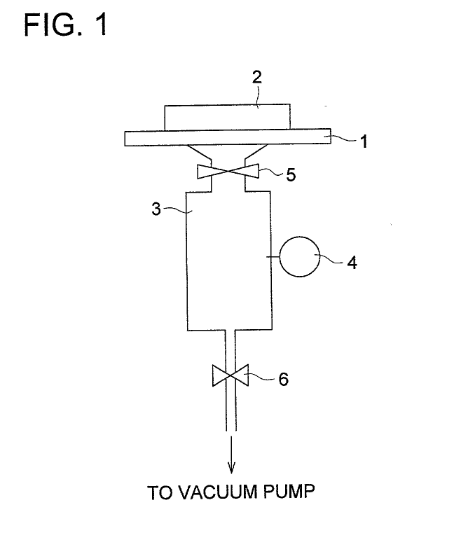

The present invention will now be detailed. There are considered to be two types of voids, that is, an independent void and a continuous void. The former means that the void forms a closed space, and the latter means that voids connect with each other so that air is allowed to pass through a connected void. When voids are formed in materials, utilizing foaming, evaporation energy during drying, or the like, both are formed. Further, even though continuous voids are formed, if the air path is narrow, continuous voids exhibit quality similar to the independent void due to viscous resistance of air. In the present invention, both the ratio of continuous voids and the air passing degree of the continuous void are evaluated, and the results are shown as the continuous rate. In the present invention, said continuous ratio is from 20 to 100 percent. The method for measuring the continuous ratio of the present invention will now be described with reference to FIG. 1. FIG. 1 is a schematic view of an apparatus to measure the continuous ratio of a sample. The size of Sample 1 is standardized to 15×15 cm, and said Sample 1 is placed while its ink absorptive layer faces downward. Subsequently, a uniform load is applied to Sample 1 utilizing pressing plate 2 having a smoothed surface, so that Sample 1 is fixed without movement. The load by pressing plate 2 is determined by the following way. Before measuring the continuous ratio of Sample 1, polyethyleneterephthalate film having thickness of 100 μm is provided in place of Sample 1, and a minimum load that air leak from contacting surface of the apparatus with the polyethyleneterephthalate film is not observed is measured. The load by pressing plate 2 is the minimum load thus measured.

In vacuum chamber 3, pressure sensor 4 is provided, whereby it is possible to digitally read the interior pressure.

First, switch valve 5 is closed, and subsequently, switch valve 6 is opened until air in vacuum chamber 3 is exhausted to a pressure of no more than 2.670×10⁴ Pa, employing a vacuum pump. When the pressure reaches the target value, switch valve 6 is closed while switch valve 5 is opened. As a result, exterior air enters into said vacuum chamber 3 through an ink absorptive layer, and the pressure of said vacuum chamber gradually increases. Until the pressure of said vacuum chamber reaches 8.000×10⁴ Pa, the resulting pressure variation is subjected to computer monitoring. Then a pressure increase rate per unit time (in seconds) is determined at 4.000×10⁴ Pa. The value obtained by dividing the resulting pressure increase rate by the thickness of said ink absorptive layer is designated as Q1. In the same manner, a pressure increase rate of a 100-micron thick sheet of paper for use in plain paper copiers (having basis weight of 65 g/m²) is determined. The obtained rate is divided by the thickness of the sheet, and the resulting value is designated as Q0. The contacting portion of the reducing pressure apparatus to the sample 1 is a circle having diameter of 9 cm.

The continuous ratio of the present invention is expressed as a percentage which is obtained by being compared to that of a sheet of paper for use in plain paper copiers. Namely, said ratio is calculated as 100×Q1/Q0.

The ink jet recording material of the present invention comprises voids which receive ink. The continuous ratio of said voids is determined as above, and is from 20 to 100 percent, and further, the difference in the continuous ratio before and after image formation is from 5 to 100 percent. In this instance the continuous ratio after image formation is measured in the following way. A solid black image having density of 2.0 is formed on the whole page of an ink jet recording material by employing an ink jet printer. The recorded material is dried for 4 hours at 30% RH and 25° C. Then the continuous ratio is measured. The density is measured by a densitometer such as PDA-65, product by Konica Corporation.

The ink jet recording material of the present invention comprises an ink absorptive layer. Said ink absorptive layer comprises at least 30 percent of voids which are formed employing organic materials. Further, said voids are preferably formed employing a foaming reaction, and voids are preferably formed in said ink absorptive layer, employing particles comprised of organic particles, having a primary particle diameter of from 0.005 to 10 microns, are connected to each other. Organic materials, which are preferably employed to form voids, include unsaturated carboxylic acids such as methacrylic acid, acrylic acid, and the like or esters thereof, polymers or copolymers obtained employing synthetic resin monomers such as styrene, and the like, water dispersion based polyester, polyurethane, polyethyleneimine, epoxy resins and the like.

An example of means to attain the specific continuous ratio according to the invention is to employ the organic particles at a ratio of 1/1 to 1/3.5 by weight to a binder of the ink absorptive layer.

Listed as synthetic resin monomers employed in the present invention are styrene and derivatives thereof; unsaturated carboxylic acids such as, for example, methacrylic acid, acrylic acid, itaconic acid, and esters thereof such as, for example, alkyl acrylate, alkyl methacrylate (alkyl groups include a methyl group, an ethyl group, a n-propyl group, an isopropyl group, a n-butyl group, an isobutyl group, a t-butyl group, a 2-ethylhexyl group, a cyclohexyl group, a phenol group, a benzyl group, a phenylethyl group, and the like); hydroxy containing monomers such as 2-hydroxyethyl acrylate, 2-hydroxyethyl methacrylate, 2-hydroxypropyl acrylate, 2-hydroxypropyl methacrylate, and the like; amide containing monomers such as acrylamide, methacrylamide, N-methylmethacrylamide, N-methylacrylamide, N-methylolmethacrylamide, N-methylolacrylamide, N,N-dimethylolacrylamide, N-methoxymethylacrylamide, and the like; amino group containing monomers such as N,N-diethyl aminoethyl acrylate, N,N-diethyl aminomethacrylate, and the like; epoxy group containing monomers such as glycidyl acrylate, glycidyl methacrylate, and the like; carboxyl group or its salt containing monomers such as acrylic acid, methacrylic acid salts (sodium salts, potassium salts, and ammonium salts), and the like; sulfonic acid group or its salt containing monomers such as styrenesulfonic acid, vinylsulfonic acid, and their salts (sodium salts, potassium salts, and ammonium salts); carboxyl group or its salt containing monomers such as itaconic acid, maleic acid, fumaric acid salts (sodium salt, potassium salts, and ammonium salts), and the like; acid anhydride, such as maleic anhydride, itaconic anhydride, and the like, containing monomers; and others such as vinyl isocyanate, allyl isocyanate, vinyl methyl ether, vinyl ethyl ether, acrylonitrile, vinyl acetate, and the like. Said monomers may be copolymerized individually or in combinations of two or more types.

Employed as organic materials may be rubber materials. Said rubber materials are commonly comprised of vinyl monomer-diolefin. Herein, preferably employed as vinyl monomers are styrene, acrylonitrile, methacrylonitrile, methyl methacrylate, methyl acrylate, vinyl acetate and the like, while preferably employed as diolefins are butadiene, isoprene, and chloroprene. Along with these components, preferably incorporated are crosslinkable components such as acrylic acid, methacrylic acid, itaconic acid, maleic anhydride as unsaturated acids, or alkyl esters thereof, acrolein, methacrolein, glycidyl acrylate, glycidyl methacrylate, 2-hydroxyethyl acrylate, 2-hydroxyethyl methacrylate, allyl acrylate, allyl methacrylate, N-methylolacrylamide, N-methylolmethacrylamide, vinyl isocyanate, allyl isocyanate, and the like.

The content of diolefin is preferably from 10 to 60 percent by weight.

Listed as preferable polymers, which are readily commercially available, may be styrene-butadiene, styrene-isoprene, styrene-chloroprene, methyl methacrylate-butadiene, acrylonitrile-butadiene, and the like.

Polymerization methods include, for example, an emulsion polymerization method, a solution polymerization method, a block polymerization method, a suspension polymerization method, a radiation polymerization method, and the like.

In solution polymerization, a monomer mixture having an appropriate concentration in solvents (commonly having a concentration of no more than 40 percent by weight with respect to solvents, and preferably from 10 to 25 percent by weight) is subjected to polymerization under the presence of initiators at about 10 to about 200° C., preferably at 30 to 120° C. for about 0.5 to about 48 hours, and preferably for 2 to 20 hours.

Employed as said initiators may be those which are soluble in polymerization solvents. Listed as initiators may be, for example, organic solvent based initiators such as benzoyl peroxide, azobisisobutyronitrile (AIBN), di-tertiary-butyl peroxide, and the like; water-soluble initiators such as ammonium persulfate, (APS), potassium persulfate, 2,2′-azobis-(2-amdinopropane)-hydro chloride, and the like; and redox based polymerization initiators which are combined these with reducing agents such as Fe²⁺ salts, sodium hydrogen sulfite, and the like.

Employed as solvents may be those which dissolve monomer mixtures. For example, listed may be water, methanol, ethanol, dimethyl sulfoxide, dimethylformamide, dioxane, or solvent mixtures comprised of at least said solvents.

After finishing of polymerization, the reaction mixture is poured into a medium which does not dissolve the formed copolymer. Products are then precipitated, and subsequently dried. Thus, it is possible to separate and eliminate the unreacted mixture.

In emulsion polymerization, water is employed as a dispersion medium, and monomers having a concentration of 10 to 50 percent by weight with respect to water, polymerization initiators having a concentration of 0.05 to 5 percent by weight with respect to said monomers, and dispersion media having a concentration of 0.1 to 20 percent by weight are subjected to polymerization while stirring at about 30 to about 100° C., and preferably at 60 to 90° C. for 3 to 8 hours. It is possible to widely and readily change the monomer concentration, the amount of initiators, the reaction temperature, the time, and the like.

Listed as initiators may be water-soluble peroxides (for instance, potassium persulfate, ammonium persulfate, and the like), water-soluble azo compounds (for instance, 2,2′-bis-(2-amidinopropane)-hydro chloride, and the like), or redox based polymerization initiators which are combined these with reducing agents such as Fe²⁺ salts or sodium hydrogen sulfite.

Listed as dispersing agents are anionic surface active agents, nonionic surface active agents, water-soluble polymers, and the like. The molecular weight of polymers obtained as above may vary depending on their use, and is commonly from about 500 to 5,000,000 in terms of polystyrene or polyethylene oxide, and is preferably from 1,000 to 500,000.

Methods for polymerizing hydrophobic polymers are detailed in U.S. Pat. Nos. 2,852,386, 2,853,457, 3,411,911, 3,411,912, and 4,197,127; Belgian Patent Nos. 688,882, 691,360, and 712,823; Japanese Patent Publication No. 45-5331; Japanese Patent Publication Open to Public Inspection Nos. 60-18540, 51-130217, 58-137831, and 55-50240; and others.

Any hydrophobic polymers having an average particle diameter of from 0.01 to 2.0 μm may be preferably employed, and those having the same of from 0.05 to 0.8 μm are most preferably employed.

Hydrophobic polymers, when polymerized in organic solvents, may be employed upon replacing solvents with water by further dispersing into water and reducing the pressure.

Water-dispersible polyesters, which may be employed in the present invention, are substantially linear polymers which are obtained employing condensation polymerization of polybasic acids or ester forming derivatives thereof, sulfonic acid group containing dicarboxylic acids and/or ester forming derivatives thereof, and polyols or ester forming derivatives thereof. Illustrated as polybasic acid components of said polymers are terephthalic acid, isophthalic acid, phthalic anhydride, 2,6-napthalehedicarboxylic acid, 1,4-cyclohexanedicarboxylic acid, adipic acid, sebacic acid, trimellitic acid, pyromellitic acid, and dimer acid. Along with these components, it is possible to employ, in an amount of small ratio, unsaturated polybasic acids such as maleic acid, fumaric acid, itaconic acid, and the like, hydroxycarboxylic acids such as p-hydroxybenzoic acid, p-(β-hydroxyethoxy)benzoic acid, and the like.

Further, illustrated as polyol components may be ethylene glycol, diethylene glycol, 1,4-butanediol, neopentyl glycol, dipropylene glycol, 1,6-hexanediol, 1,4-cyclohexanedimethanol, xylylene glycol, trimethylolpropane, poly(ethyleneoxide)glycol, poly(tetramethyleneoxide)glycol and the like.

In order to provide water dispersibility as well as water solubility to said water-dispersible polyesters, a method is preferably utilized in which sulfonic acids salts, polyethylene glycol, polyalkylene ether glycol, and the like, are introduced. Specifically, it is preferable that dicarboxylic acid components having sulfonic acid salts (carboxylic acids comprising sulfonic acid salts and/or ester forming derivatives thereof) are incorporated into water-dispersible polyester in an amount of 5 to 15 mole percent with respect to the total dicarboxylic acid components.

Specifically preferred as dicaroboxylic acids, comprising sulfonic acid salts and/or ester forming derivatives thereof, are those having sulfonic acid alkaline metal salt groups. For example, employed may be alkaline metal salts of 4-sulfoisophthalic acid, 5-sulfophthalic acid, sulfoterephthalic acid, 4-sulfophthalic acid, 4-sulfonaphthalene-2,7-dicarboxylic acid, 5-(4-sulfophenoxy)isophthalic acid, and the like, or ester forming derivatives thereof. Of these, particularly preferred are sodium salt of 5-sulfoisophthalic acid or ester forming derivatives thereof. From the point of water solubility as well as water resistance, these dicarboxylic acids having the sulfonic acid salts and/or ester forming derivatives thereof are most preferably employed in an amount of 6 to 10 mole percent, with respect to the total dicarboxylic acid components.

Further, copolymers are preferred which are comprised of water dispersible polyester and styrene based polymers as the constituting component. Said polymers are copolymers which are comprised of said water dispersible polyesters and styrene based polymers as the constituting components or compositions.

The water dispersible polyesters, as described herein, refer to linear polymers which are obtained by employing a condensation polymerization reaction of said polybasic acids or polyester forming derivatives thereof with polyols or ester forming derivatives thereof.

Peroxides, which may be employed in the present invention, are preferably water soluble, even though those, which are not soluble in water, may be dispersed into water and employed. Listed as water-soluble peroxides are initiators such as, for example, water-soluble peroxides (for example, potassium persulfate, ammonium persulfate, and the like), as well as hydrogen peroxide, which are employed in the synthesis of vinyl polymers. However, from the ease of handling, hydrogen peroxide is preferred. The employed amount of hydrogen peroxide is preferably from 0.1 to 30 percent by weight with respect to the solids of the sublayer in terms of the effective amount, and is more preferably from 1 to 10 percent by weight.

organic materials, which form the voids of the present invention, are preferably organic material particles, and organic material particles are more preferred which have a structure such that at least 3 primary particles having a diameter of from 0.005 to 10 microns are connected.

The ink jet recording material of the present invention preferably comprises an ink absorptive layer having voids which are formed utilizing a foaming reaction. Said voids are formed in the ink absorptive layer employing the foaming reaction in such a manner that the aforementioned rubber materials are employed as the organic materials, and organic foaming agents, which generate nitrogen gas as the decomposition gas and form water-soluble decomposition products, foaming aids which lower the decomposition temperature of said organic foaming agents and water, are mixed and heated. Organic foaming agents include, for example, dinitrosopentamethylenetetramine, and the like, and the foaming agents include citric acid, and the like.

In the ink absorptive layer of the recording material of the present invention, it is possible to employ binders. As said binders, it is possible to employ hydrophilic binders as well as hydrophobic binders.

Employed as hydrophilic binders are, for example, gelatin, polyvinylpyrrolidone, polyethylene oxide, polyacrylamide, and polyvinyl alcohol, all of which are conventionally known in the art. Of these, polyvinyl alcohols are particularly preferred.

Polyvinyl alcohols, which are preferably employed in the present invention, include, other than common polyvinyl alcohol which is obtained by hydrolyzing polyvinyl acetate, modified polyvinyl alcohols such as one which is subjected to cationic modification at the terminal, anion modified polyvinyl alcohol having an anionic group, and the like.

Of polyvinyl alcohols which are obtained by hydrolyzing vinyl acetate, one having an average degree of polymerization of at least 300 is preferably employed, and one having the same of 1,000 to 4,000 is most preferably employed.

Polyvinyl alcohol having a saponification ratio of from 70 to 100 percent is preferred, and one having the same of from 80 to 99.5 percent is particularly preferred.

Cation modified polyvinyl alcohols include, for example, one having any of a primary, secondary, tertiary amine and a quaternary ammonium group in the main chain or the branch chain of said polyvinyl alcohol, as described in Japanese Patent Publication Open to Public Inspection No. 61-10483, which is obtained by saponifying the copolymer of ethylenic unsaturated monomers having a cationic group, and also vinyl acetate.

Listed as ethylenic unsaturated monomers having a cationic group are, for example, trimethylol(2-acrylamide-2,2-dimethyethyl)ammonium chloride, trimethyl-(3-acrylamide-3,3-dimethylpropyl)ammonium chloride, N-vinylimidazole, N-vinyl-2methylimidazole, N-(3-dimethylaminopropyl) methacrylamide, hydroxylethyltrimethylammonium chloride, trimethyl-(methacrylamidopropyl) ammonium chloride, trimethyl-(methacrylamidopropyl) ammonium chloride, N-(1,1-dimethyl-3-dimethylaminopropyl) acrylamide, and the like.

The ratio of cation modified group-containing monomers of said cation modified polyvinyl alcohol is commonly from 0.1 to 10 mole percent with respect to vinyl acetate, and is preferably from 0.2 to 5 mole percent.

Listed as anion modified polyvinyl alcohols are, for example, polyvinyl alcohol having an anionic group as described in Japanese Patent Publication Open to Public Inspection No. 1-206088, copolymers of vinyl alcohol and vinyl compounds having a water solubilizing group as described in Japanese Patent Publication Open to Public Inspection Nos. 61-237681 and 63-307979, and polyvinyl alcohol having a water solubilizing group as described in Japanese Patent Publication Open to Public Inspection No. 7-285265.

Further, listed as nonion-modified polyvinyl alcohols are, for example, polyvinyl alcohol derivatives in which a polyalkylene oxide group is added to that part of polyvinyl alcohol, as described in Japanese Patent Publication Open to Public Inspection No. 7-9758, block polymers of vinyl compounds having a hydrophobic group with vinyl alcohol as described in Japanese Patent Publication Open to Inspection No. 8-25795.

Polyvinyl alcohols may be employed in combination of two or more, in which the degree of polymerization, types, and the like, differ.

Employed as water non-absorptive supports used as the recording material of the present invention may be any of those known in the art. For example, employed may be polyester based film, diacetate based film, triacetate based film, acryl based film, poly carbonate based film, polyvinyl chloride based film, and polyimide based film; transparent film comprised of cellophane, celluloid, and the like; and translucent or opaque supports such as resin coated paper (so-called RC paper) comprising a base paper having on at least one surface a polyolefin resin coated layer comprising white pigments and the like, and so-called white PET is prepared by adding white pigments such as titanium oxide, barium sulfate, and the like, to polyethylene terephthalate.

When the coating composition of the present invention is applied to any of said supports, said supports are preferably subjected to corona discharge treatment, subbing treatment, and the like, for the purpose of an increase in adhesion between the support surface and the coated layer. Further, the recording materials of the present invention need not always be colorless, but may be tinted.

The supports, which are most preferably employed in the present invention, include transparent polyester film, opaque polyester film, opaque polyolefin resinous film, and paper support laminated with polyethylene on both sides.

Paper supports laminated with polyethylene are specifically preferred. Said supports will now be described.

Base paper, employed as paper supports, employ wood pulp as the main raw material and if desired, together with synthetic pulp such as polypropylene, and the like, and synthetic fiber such as nylon, polyester, and the like. Employed as said wood pulp may be any of LBKP, LBSP, NBKP, NB SP, LDP, NDP, LUKP, and NUKP. Of these, LBKP, NBSP, LBSP, NDP, and LDP, comprised of short fibers, are preferably employed in high ratio amounts. Incidentally, the ratio of LBSP and/or LDP is preferably from 10 to 70 percent by weight.

Of said pulp, chemical pulp (sulfate pulp and sulfite pulp) comprised of minimum impurities is preferably employed. Further, the pulp, which is subjected to enhancement of whiteness through a bleaching treatment, is also preferably employed.

Into base paper, suitably incorporated, may be sizing agents such as higher fatty acids, alkyl ketene dimers, and the like; white pigments such as calcium carbonate, talc, titanium oxide, paper strength enhancing agents such as starch, polyacrylamide, polyvinyl alcohol, and the like; optical brightening agents, moisture maintaining agents, dispersing agents, softening agents such as quaternary ammonium and the like; and the like.

The freeness of pulp employed for paper making is preferably from 200 to 500 ml in accordance with CSF Standard.

Further, the fiber length after beating is preferably from 30 to 70 percent which is the sum of 24-mesh residual percent by weight, and 42-mesh residual percent by weight specified in JIS-P-8207. Still further, 4-mesh residual percent by weight is preferably no more than 20 percent by weight.

The weight of base paper is preferably from 30 to 250 g/m², and is most preferably from 50 to 200 g/m². The thickness of said base paper is preferably from 40 to 250 μm.

Base paper may be subjected to calendering during paper making, or after paper making, to provide high smoothness. The density of base paper is commonly from 0.7 to 1.2 g/m² (JIS-P-8118). Further, the stiffness of base paper is preferably from 20 to 200 g under conditions specified in JIS-P-8143.

The surface of base paper may be coated with sizing agents. Employed as said surface sizing agents may be sizing agents which are the same as those incorporated into said base paper.

The pH of said base paper, when measured employing a hot water extraction method specified in JIS-P-8113, is preferably from 5 to 9.

Polyethylene, which is laminated onto the surface and back of base paper is mainly comprised of low density polyethylene (LDPE) and/or high density polyethylene (HDPE). Other than these, polypropylene and the like may be partially employed.

Specifically, the polyethylene layer on the coated layer side is preferably one in which opacity as well as whiteness is improved by adding rutile or anatase type titanium oxide into polyethylene, as is widely applied to photographic paper. The content ratio of titanium oxide is commonly from 3 to 20 percent by weight with respect to polyethylene, and is preferably from 4 to 13 percent by weight.

Said polyethylene laminated paper may be employed a glossy paper. Further, in the present invention, papers with a matte surface and silk surface may be employed, which are prepared in such a manner that when polyethylene is melt-extruded onto the surface of said base paper, a so-called embossing treatment is carried out.

The amount of polyethylene, employed on the surface and back of base paper, is determined so that curling is optimized under low and high humidity, after providing a backing layer while taking into account the thickness of a water based coating composition layer. The thickness of the polyethylene layer of the side, onto which the water based coating composition of the present invention is applied, is from 20 to 40 μm, while the thickness of the same of the backing layer side is from 10 to 30 μm.

Further, said polyethylene laminated paper support preferably exhibits the characteristics described hereunder.

(1) Tensile strength: the strength determined by the method specified in JIS-P-8113 is preferably from 2 to 30 kg in the longitudinal direction and from 1 to 20 kg in the lateral direction

(2) Tear strength: the tear strength determined by the method specified in JIS-P-8115 is preferably from 10 to 200 g in the longitudinal direction and from 20 to 200 kg in the lateral direction

(3) Compression elastic modulus ≧10³ kgf/cm²

(4) Surface Beck smoothness: at least 20 seconds are preferred for glossy surface under conditions specified in JIS-P-8119. However, so-called embossed supports may have a value less than 20 seconds.

(5) Opacity: the transmittance of visible light is no more than 20 percent under measurement conditions of a straight light incidence/diffused light transmission condition, and is most preferably no more than 15 percent.

Other than those previously described, various types of additives may be incorporated into the coating compositions which form the aforementioned first and second porous layers.

Of these, cationic mordant is preferred due to the improvement of water resistance as well as moisture resistance after printing. Employed as mordant are polymer mordants having primary, secondary, and tertiary amino groups, and quaternary ammonium salt groups. Of these, polymer mordants having the quaternary ammonium salt group are preferred due to minimized staining, minimized degradation of light fastness, sufficiently high mordant capability of dyes, and the like.

Preferred polymer mordants are obtained as homopolymers of a monomer having said quaternary ammonium salt group, and copolymers or condensation polymers of other monomers.

Other than those, as previously described, also incorporated may be various additives known in the art, such as, for example, UV absorbers described in Japanese Patent Publication Open to Public Inspection Nos. 57-74193, 57-87988, and 62-261476, antifading agents described in Japanese Patent Publication Open to Public Inspection Nos. 57-74192, 57-87989, 60-72785, 61-146591, 1-95091, 3-13376, and others, optical brightening agents described in Japanese Patent Publication Open to Public Inspection Nos. 59-42993, 59-52689, 62-280069, 61-242871, 4-219266, and others, antifoaming agents, lubricants such as ethylene glycol, and the like, antiseptics, thickeners, antistatic agents, matting agents, and the like.

Methods for applying said coating compositions onto a support and subsequently drying the coating will now be described.

Employed as coating methods may be a roll coating method, a rod bar coating method, an air knife coating method, a spray coating method, and a curtain coating method. Further, preferably employed is an extrusion coating method employing a hopper, described in U.S. Pat. No. 2,681,294.

The temperature of the coating composition of the present invention during coating is preferably from 30 to 50° C., and is most preferably from 36 to 48° C.

After applying the coating composition of the present invention onto a support, as previously described, it is preferable that the coated composition be cooled and subsequently subjected to a marked increase in viscosity.

The cooling temperature is preferably set at no more than 20° C., and is most preferably set at no more than 15° C.

Cooling after coating may be achieved by preferably passing materials through a cooling zone maintained at no more than 10° C. for specific time (preferably at least 5 seconds). During said cooling, it is preferable that a strong airflow no be applied so that unevenness of the coating composition does not occur.

After once cooling, even though a strong airflow is employed, said unevenness of the coating composition tends not to occur due to an increase in viscosity. Thus the generation of said unevenness of the coating composition is minimized, even though a strong airflow is applied. It is possible to apply airflow at a temperature of at least 20° C. However, it is preferable that the temperature of airflow gradually increases.

Depending on the wet thickness, drying time is commonly within about 10 minutes, and is most preferably within 5 minutes.

Depending on the wet thickness, as well as drying capacity of facilities, coating speed is from about 10 to about 1,000 m per minute, and is preferably from 20 to 500 m per minute.

In the recording materials of the present invention, in order to minimize curling as well as adhesion between stacked materials immediately after printing, and to further improve ink transfer, it is preferable that various types of backing layers are arranged on the back of supports.

The constitution of said backing layer varies depending on the types and thickness of the support, as well as on the constitution of the surface side and its thickness, for which hydrophilic binders as well as hydrophobic binders are commonly employed. The thickness of said backing layer is commonly in the range of from 0.1 to 1 μm.

Further, in order to minimize adhesion to other recording materials, to improve writability, and to further improve the conveyance properties in the ink jet recording apparatus, it is possible to roughen the surface of said backing layer. For achieving said objective, fine organic or inorganic particles, having a diameter of 2 to 20 μm, are preferably employed.

Said backing layer may be previously provided or may be provided after coating compositions of the present invention.

### EXAMPLES

The present inventions will now be described with reference to examples. Further, “%” in the examples is absolute dry percent by weight, unless otherwise specified, and each of the addition amounts is an amount per m² of the ink jet recording sheet.

### Example 1

Sample No. 1 was obtained by applying layers, Layer 1 and Layer 2, having constitutions described below in (said order onto the recording surface of a 180 μm thick water absorptive paper support so as to obtain a dried layer thickness of 3 μm and 20 μm, respectively, and subsequently drying the resulting coating.

| (Layer 1) | | |
|---|---|---|
| Hydrophilic binder: acid process | 6 | g |
| gelatin (having an isoelectric | | |
| point of 8.5)/polyvinyl alcohol | | |
| (PVA 203, manufactured by | | |
| Kuraray Co., Ltd.) = 6/4 (in | | |
| weight ratio) | | |
| Polymer latex: styrene-butadiene latex | 14 | g |
| butadiene/styrene/acrylic acid = | | |
| 58/40/2, monomer amount ratio | | |
| in % by weight) | | |
| Surface active agent: saponin | 0.02 | g |
| (Layer 2) | | |
| Fine particle silica dispersion (1) | 450 | ml |
| described below | | |
| Cationic polymer (1) described below | 2 | g |
| Ethanol | 35 | ml |
| n-Propanol | 10 | ml |
| Ethyl acetate | 5 | ml |
| Polyvinyl alcohol (PVA 203, manufactured | 0.1 | g |
| by Kuraray Co., Ltd.) | | |
| Polyvinyl alcohol (PVA 235, manufactured | 12 | g |
| by Kuraray Co., Ltd.) | | |
| Boric acid | 2.0 | g |
| Borax | 1.0 | g |

Fine particle silica dispersion (1): added to 400 ml of pure water were 80 g of A300 manufactured by Nippon Aerosil Kogyo Co., Ltd. The resulting mixture was dispersed employing a high speed homogenizer, and subsequently, the total volume was adjusted to 450 ml by adding pure water.

Cationic polymer (1)

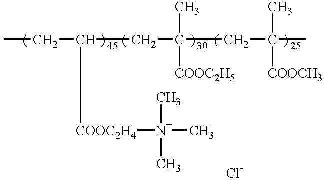

Subsequently, Sample Nos. 2 through 6 were prepared in the same manner as Sample No. 1, except that the addition amount of the hydrophilic binder, well as of the latex of “Layer 1”, were changed as described in Table 1.

Subsequently, each of the obtained Samples was subjected to evaluation of items described below. Table 1 shows the results.

Continuous Ratio

The continuous ratio was determined employing the aforementioned continuous ratio measurement apparatus shown in FIG. 1.

Void Ratio

The void ratio was obtained based on the formula described below:

Void ratio=100×[(total dried layer thickness−coated solid thickness)]/(total dried layer thickness)]

Cracking and the Like 7

The state of each sample was visually evaluated.

TABLE 1

| | Hydro- | | | | Void | | | | | | |
|---|---|---|---|---|---|---|---|---|---|---|---|
| | philic | Polymer | Continuous | | Ratio | | | | | | |
| | Binder | Latex | Ratio | | in % | | Ink | | Water | Moisture | |
| No. | g/m² | g/m² | (in %) | | (V/V) | Cracking | Absorption | Image | Proof | Proof | Glossiness |
| 1 | 6 | 14 | 85 | 60 | 61 | no cracking | Good | Good | Good | Good | Good |
| 2 | 8 | 12 | 60 | 55 | 43 | no cracking | Good | Good | Good | Good | Good |
| 3 | 10 | 10 | 35 | 25 | 32 | inferior | Good | Good | Good | Good | Good |
| | | | | | | haze | | | | | |
| 4 | 4 | 20 | 15 | 0 | 61 | independent | Bleed | Slight | Good | Bleed | Not |
| | | | | | | bubbles | | Blur | | | acceptable |
| 5 | 4 | 16 | 8 | 0 | 60 | independent | Bleed | Slight | Good | Bleed | Not |
| | | | | | | bubbles | | Blur | | | acceptable |
| 6 | 12 | 8 | 12 | 0 | 50 | independent | Bleed | Blur | Peeled | Bleed | Not |
| | | | | | | bubbles | | | | | acceptable |
| 7 | 2 | 18 | 120 | 0 | 0 | Cracking at | Bleed | Blur | Peeled | Bleed | Not |
| | | | | | | surface | | | | | acceptable |

Table 1 shows that samples having a continuous ratio of voids form 20 to 100 percent are excellent while resulting in neither cracking nor other problems.

The present invention makes it possible to provide an ink jet recording material having a layer strength which minimizes the generation of minute cracking and spotted coating problems, and to provide a novel evaluation method for ink absorbability, which has not been sufficiently evaluated employing the conventional evaluation method.

1. An ink jet recording material comprising a support and provided thereon an ink absorptive layer wherein the ink jet recording material has continuous ratio of voids of from 20 to 100 percent.

2. An ink jet recording material of claim 1, wherein the difference in the continuous ratio of voids before and after image formation is from 5 to 100 percent.

3. The ink jet recording material of claim 1, wherein said ink absorptive layer contains at least 30 percent of voids formed by employing organic materials.

4. The ink jet recording material of claim 1, wherein the ink absorptive layer contains voids which are composed of a component having ink absorbability.

5. The ink jet recording material of claim 1, wherein the ink absorptive layer is composed of at least two layers.

6. The ink jet recording material of claim 6, wherein the ink absorptive layer is composed of at least two layers, and at least one layer comprises at least 30 percent of voids formed by employing organic materials.

7. The ink jet recording material of claim 6, wherein at least one layer contains voids; and a layer provide closer to the support than the layer containing voids has ink absorbability.
